(19) United States
(12) Patent Application Publication
(10) Pub. No.: US 2009/0081807 A1
(43) Pub. Date: Mar. 26, 2009

(54) METHOD FOR RAPID AND QUANTITATIVE ASSAY USING PRIMARY COLOR PRINCIPLE

(76) Inventors: April Cui, San Diego, CA (US); Xu Cui, Mountain View, CA (US)

Correspondence Address: April Cui, 3619 Syracuse Ave, San Diego, CA, US

(21) Appl. No.: 11/861,265

(22) Filed: Sep. 25, 2007

(51) Int. Cl. G01N 21/00

(52) U.S. Cl. 436/164

(57) ABSTRACT

A method for rapid and quantitative assay of fluid specimen is disclosed. This method utilizes the principle of primary colors: any color can be discomposed into three primary colors or multiple primary colors (for example, red, green and blue). The molecules of the chemical being measured are bound to three colored substrates at different binding constant. Thus different concentration of the chemical will result in different final colors chromatography imaging. This makes the quantitative assay possible. This method can also be used to detect qualitatively the existence of multiple chemicals simultaneously.

### FIELD OF THE INVENTION

The present invention relates generally to fluid specimen assay and analytical measurement of the concentration of substrates.

### BACKGROUND OF THE INVENTION

Current rapid test devices give qualitative result only (U.S. Pat. Nos. 6,576,193, 6,074,606, 4,094,647). For example, a typical PSA (Prostate specific antigen) test device can tell whether or not the concentration of PSA exceeds a threshold. PSA is produced by prostate glandular and endothelial cells. Normal PSA concentration in serum of healthy men is between 0.1-2.6 ng/ml. It can be elevated in malignant conditions such as prostate cancer, and in benign conditions such as benign prostatic hyperplasia and prostatitis. A PSA level of 4 to 10 ng/mL is considered to be in the “gray-zone” and 10 ng/mL or higher is highly indicative of cancer. A patient with a PSA value between 4-10 ng/mL thus usually needs further analysis of the prostate by biopsy. The PSA antigen test is the most commonly tool available for rapid qualitative diagnosis of early prostate cancer. On the other hand, quantitative assay devices such as mass spectroscope are extremely expensive and inconvenient for everyday use. Here we provide a new method to achieve both quantitative and rapid measure of the concentration of an interested chemical using the principle of the primary colors, any color can be discomposed into three primary colors (for example, red, green and blue).

The millions of different colors we see everyday are indeed the combinations of only three primary colors (for example, red, green and blue). Different compositions lead to different color (see FIG. 1). For example, the color magenta is composed of equal amount of red and blue.

Such decomposition of colors into three primary colors has its neural basis. The human eye contains photoreceptor cells called cone cells which normally respond mostly to yellowish-green (long wavelength or L), bluish-green (medium or M) and bluish-violet (short or S) light (peak wavelengths of 564 nm, 534 nm and 420 nm respectively). The difference in the signals received from the three kinds allows the brain to perceive a wide gamut of different colors, while being most sensitive (overall) to green light and to differences between shades of green. As an example, suppose that light in the yellow range of wavelengths (approximately 577 nm to 597 nm) enters the eye and strikes the retina. Light of these wavelengths would activate both the medium and long wavelength cones of the retina, but not equally—the long-wavelength cells will respond more (fire more frequently).

The difference in the response can be interpreted by the cells of the brain that the light is yellow. In this sense, the yellow appearance of objects is simply the result of yellow light from the object entering our eye and stimulating the relevant kinds of cones simultaneously but to different degrees.

That every color can be uniquely decomposed into three primary colors gives the possibility to use color to encode the amount of the interested chemicals.

### SUMMARY OF THE INVENTION

The present invention is directed to solving the problems of the existing rapid test method, i.e., non-quantitative. The method comprises of 6 steps: (1) color labeling (i.e., label the substrates which bind the interested chemical with colors); (2) quantitative sampling of specimen; (3) reaction phase: reaction or binding between the interested chemical and the primary colored substrates; (4) capture/separation phase: capture or separation of the substrates which are bound to the interested chemical from those which are not; (5) stabilize; (6) result reading. Some of the steps may be omitted depending on the situation.

The reaction system comprises of three different substrates, each with a different color (for example, red, green and blue). The three substrates bind the interested chemical with different binding constant. Depending on the concentration of the interested chemical, the chemical will bind the three substrates at different levels and result in a different final color imaging.

The colors don't have to be conventional primary colors, red, green and blue. They can be any color, including colors invisible to naked human eyes such as infrared (in this case the result is read by special machines).

In one variation, the three substrates can bind to three different chemicals instead of one. Thus the resulted color is a qualitative indication of the existence of any of the three interested chemicals.

In another variation, one can use only two, or four, or other number of substrates each with a different color. Even though three are adequate, two, four, or other numbers may be more suitable for specific cases.

The system also comprises a calibration table where the users can find the concentration from color.

### BRIEF DESCRIPTION OF THE FIGURES

FIG. 1 illustrates the principle of primary colors: every color can be decomposed into three primary colors.

FIG. 2 illustrates the steps of this quantitative measuring method.

FIG. 3 illustrates the calibration table.

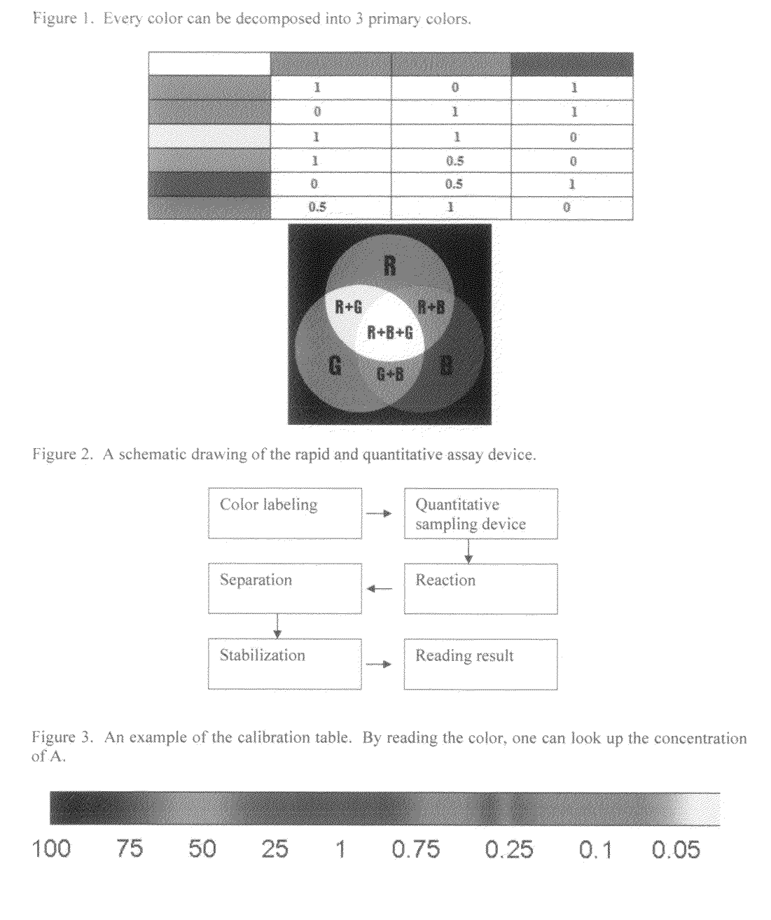

### DETAILED DESCRIPTION OF THE INVENTION

Provided herein is a fluid specimen assay method. In this method, the system contains 6 steps (FIG. 2).

### 1) Color Labeling

The first step is to label the substrates which will bind the interested chemical with color. For example, one may label such substrates with dye, fluorescence, bead, gold, or latex, etc. If the substrates have color already, this step may be omitted.

### 2) Quantitative Sampling

The second step is quantitative sampling, i.e., taking a fixed amount of specimen which will participate the reaction. This step is necessary to achieve quantitative measurement of the interested chemicals.

### 3) Reaction Phase:

The third step is reaction. A container contains the colored substrates. These substrates are able to bind with the interested chemicals with different binding constant. Let's say the substrates are A, B and C, etc and the interested chemical is X. The colors of A, B, and C are red, green, and blue, respectively. Assuming the binding constant between A and X, between B and X, and between C and X, are 1, 100, 1000, respectively. Thus the three substrates will compete to bind with X. Different concentration of X will produce different amount of A, B and C which binds with X.

The reactions can be simultaneous, meaning the substrates can react with the interested chemical at the same time, or can be separate. If separate, the substrates can be mixed later.

We call the substrates which are bound with X bound substrates, those which are not called excess substrates.

### 4) Separation

In the fourth step, a washing procedure is applied to separate the bound substrates and excess substrates. For example, one can use chromatography with the antibody of X to separate the substrates.

### 5) Stabilization

The fifth step is to stabilize the bound substrates, or excess substrates, or both. One can use the method of chromatography to solidify the substrates. This step is omittable.

### 6) Results Interpretation

Finally, the final color is read by naked eyes or by reading machines. Then the color is compared to a standard color table to find the concentration of the interested chemicals.

For example, if the concentration of X is extremely low, X will bind C primarily and the final color is blue; more A will make the color more green and red. We first use X of known concentration to produce a calibration table (FIG. 3). The calibration table is simple a list of different colors and the corresponding concentration. Then the users can use such a table to find the unknown concentration.

As an example, a new PSA imaging test utilizes this three bio/immuno-primary colors and two-site sandwich immuno-chromatography technology for the quantitative detection of PSA in human specimen. PSA specific antibodies are pre-coated and/or labeling with red, green and blue primary colors. If PSA is present in the specimen, depending on the concentration, a new color will form in the test region.

The method can also be used to detect multiple chemicals simultaneously in a fluid specimen. If the colored substrates bind different chemicals (instead of one chemical with different binding constants), then we can detect the existence of them at the same time. Assume A binds X, B binds Y and C binds Z. If only Z exists in the specimen, the final color will be blue; if X and Y exist, the final color will be yellow. Like above, a reading table is provided.

Though 3 colors are common, it should be noted that 2 colors, or 4 colors or more can also be used depending on the specific system.

The colors don't have to be conventional primary colors, red, green and blue. Any colors will be fine. The colors don't have to be visible colors either (e.g., infrared). A reading machine may be needed to read invisible colors.

It should be emphasized that the colored substrates mentioned above can be complex molecules with two or more components. One component is able to bind with the interested chemical and one shows color. Thus the entire substrate both binds with the interested chemical and show color. For example, one component could be the antibody of the interested chemical and the other component could be gold.

It should also be emphasized that both bound substrates and excess substrates can be used to determine the concentration of the interested chemical. In many cases, excess substrates are easier to manipulate. In these cases, the amount of colored substrates which are applied must be known (quantitative). Again, one can read the calibration table to find the concentration of the interested chemical.

It should also be noted that the above method can be applied to solid specimen, if the specimen can be diluted in water or other liquid first.

What is claimed is:

1. A method for quantitative assay of a single chemical in fluid specimen using the principle of primary colors

2. A method for qualitative assay of multiple chemicals in fluid specimen using the principle of primary colors

3. The method consists of up to 6 steps: Color labeling, quantitative sampling, reaction, separation, stabilization and reading.

4. The number of said colors can be two, three, or more.

5. The colors can be conventional primary colors, red, green and blue.

6. The colors can be any other colors.

7. The colors can be invisible colors which can be read by a reading machine.
